(19) United States
(12) Patent Application Publication
(10) Pub. No.: US 2015/0274082 A1
(43) Pub. Date: Oct. 1, 2015

(54) Automobile Headrest Hanger Hook

(71) Applicant: Vartan Khazadian, Bethel, CT (US)

(72) Inventor: Vartan Khazadian, Bethel, CT (US)

(21) Appl. No.: 14/242,020

(22) Filed: Apr. 1, 2014

(51) Int. Cl. B60R 7/10

(52) U.S. Cl. CPC B60R 7/10

(57) ABSTRACT

A portable hook (hereto referred to as “Device”) to hang from an automobile headrest support bar to hold personal items. The Device is used to hang dry cleaning garments, grocery bags, purses, jackets and assorted garments or any other item that can hang from a hook. Device benefits are to prevent obstruction of driver's visibility of side windows while driving, to free up cabin seating space and increase storage capacity.

### BACKGROUND OF THE INVENTION

Most automobiles contain factory installed hooks attached to the rear interior cabin ceiling. They are used for hanging clothes from the dry cleaners or extra clothing such as suit jackets. However, hanging clothes from these hooks presents a problem for the driver. It obstructs the side views for the driver while he/she is operating the vehicle, thus decreasing overall safety.

Additionally, only garments can be hung from these factory hooks. Other types of items have to be stored elsewhere in the vehicle, which limits cabin seating space.

Moreover, most automobiles have only two factory installed hooks, which limits storage capacity.

### BRIEF SUMMARY OF THE INVENTION

Because of the limitations of factory installed hooks, there is a need for a device to be used in an automobile that can hang dry cleaning, assorted other garments, grocery bags, purses etc. When the Device is used to hang dry cleaning garments or any other clothing on a hanger from the headrest support bars, driver safety is increased by allowing for full side window visibility.

The Device is also able to hold different types of cargo that a factory installed hook typically is not used for. This frees up cabin seating space in the automobile that would otherwise have been used to store these personal items, such as grocery bags.

Because many Devices can be used at once, this increases the storage capacity inside the automobile beyond the limited capacity and capability of two factory installed hooks.

### BRIEF DESCRIPTION OF THE SEVERAL VIEWS OF THE DRAWING

FIG. 1 is a front perspective full view of the Device hanging onto the front of the headrest support bar of a car seat.

FIG. 2 is a front perspective full view of the Device hanging onto the rear of the headrest support bar of a car seat.

FIG. 3 is an overhead perspective view of the Device that details the physical characteristics of the Device as well as the main function of each curved hook end.

FIG. 4 is a side perspective view of the Device that details the overall shape and direction of the Device parts.

FIG. 5 is a side perspective view of the Device which details specific measurements of certain parts of the Device.

### DETAILED DESCRIPTION OF THE INVENTION

The Device prototype was manufactured and hand molded from a low temperature thermoplastic. During research and development, it safely held up to ten lbs. of weight for 24 hours. The Device weight is 0.8 oz. and is solid plastic. There are many different injection molding plastics that can be used during the manufacturing process. This Device will be commercially produced using a plastic injection molding process. The Device can alternatively be made with metal alloys such as aluminum.

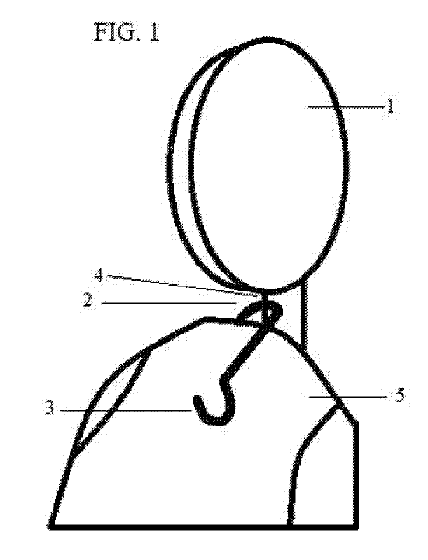

FIG. 1 is a front perspective full view of the Device hanging onto the front of the headrest support bar of a car seat. The headrest 1 is in its fully extended position. The entire Device, 2 & 3 is shown hanging from the front of the headrest support bar 4. One curved hook end 2 hooks onto the headrest support bar 4, and the other curved hook end 3 is used to hang personal items (garments, grocery bags etc.). When hanging from the headrest support bar 4, the entire Device 2 & 3 will typically rest against the seatback 5.

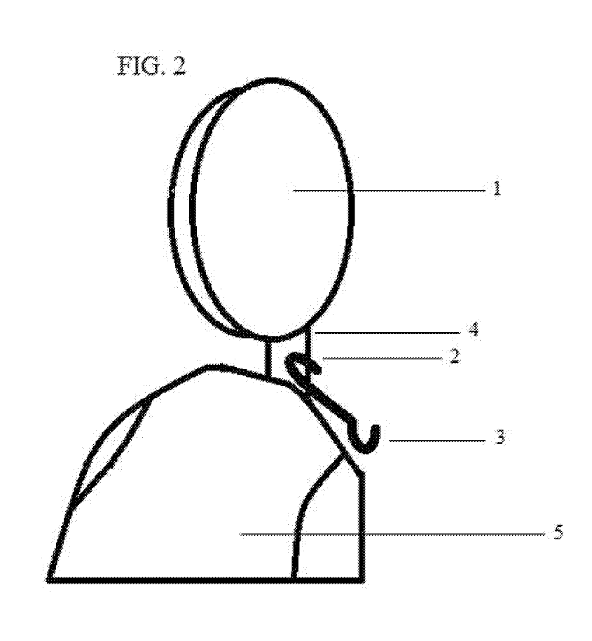

FIG. 2 is a front perspective full view of the Device hanging onto the rear of the headrest support bar of a car seat. The headrest 1 is in its fully extended position. The entire Device, 2 & 3 is shown hanging from the rear of the headrest support bar 4. One curved hook end 2 hooks onto the headrest support bar 4, and the other curved hook end 3 is used to hang personal items (garments, grocery bags etc.). When hanging from the rear of the headrest support bar 4, the entire Device 2 & 3 will either rest against the back of the seatback 5, or suspend in the air, depending on the weight of the personal items hanging from it.

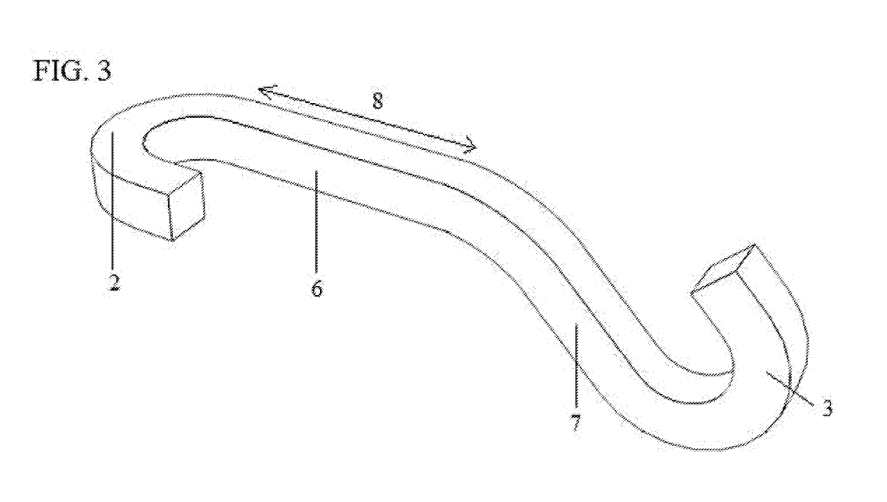

FIG. 3 is an overhead perspective view of the Device that details the physical characteristics of the Device as well as the main function of each curved hook end. The Device has four sides of equal width. Each side 6 is 0.39370 in. wide. Each end of the Device contains a curved hook end 2 & 3. One curved hook end 2 is used to hang the Device from the headrest support bar. The other end of the Device contains a curved hook end 3 that is bent at a 45 degree angle 7 towards the opposite curved hook end 2 and the center rod portion 8 of the Device. This curved hook end 3 is used to hang personal items.

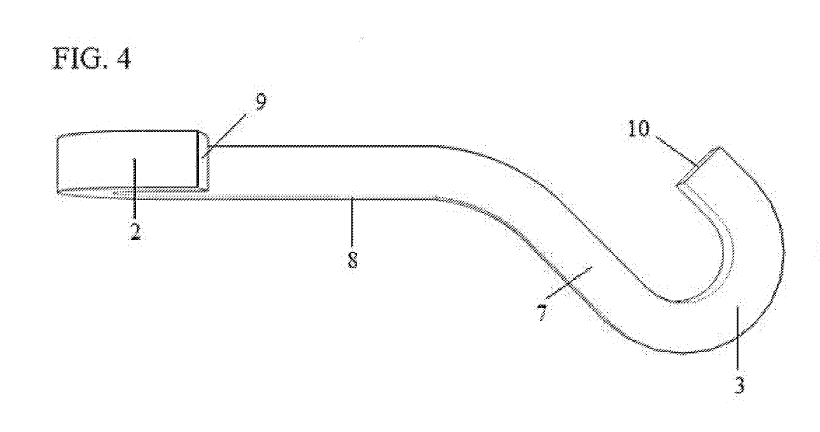

FIG. 4 is a side perspective view of the Device that details the overall shape and direction of the Device parts. The Device curved hook end 2 that hooks onto the headrest support bar is somewhat perpendicular to the opposite curved hook end 3 that is used to hang personal items. This curved hook end 3 lies at a 45 degree angle 7 towards the opposite curved hook end 2 and the center rod portion 8 of the Device. Both curved hook ends 2 & 3 terminate and face in each other's general direction 9 & 10.

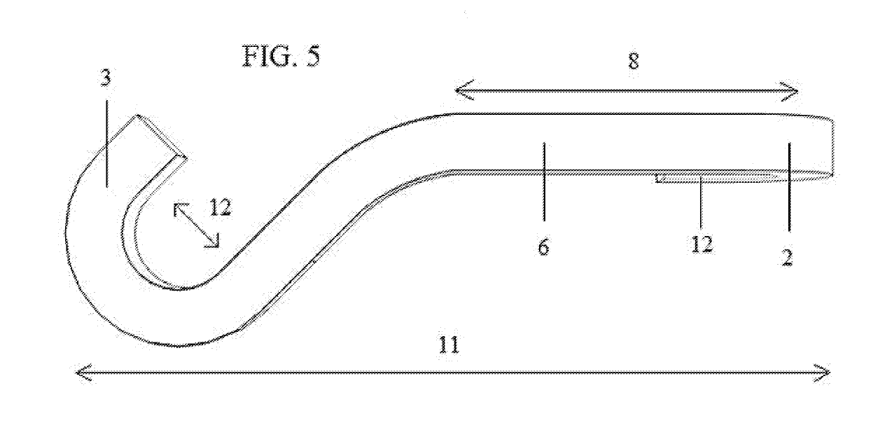

FIG. 5 is a side perspective view of the Device which details specific measurements of certain parts of the Device. The Device is 5 inches in length 11 when measured from one curved hook end 2 to the other curved hook end 3 (8 inches when measured along its entire body). The center rod portion 8 of the Device is exactly 2 inches in length (measured straight length portion before each end begins to bend toward each curved hook end). Each side 6 is 0.39370 in. wide. The inner radius 12 of each curved hook end is 0.79 in.

No additional attachments are required to use the Device. No assembly is required. The Device does not require permanent fastening to a headrest support bar or the use of any additional hardware (i.e. nuts, bolts). The Device can be placed and removed from a headrest support bar instantly, without removal or alteration of the headrest or the headrest support bar(s). The Device consists of one piece with no moving parts. The Device can be used with the headrest either extended up or extended down to the seatback. A driver can use as many Devices as there are headrest support bars in the automobile.

The Device should not be used while a passenger is sitting in any seat that the Device is hanging from or in front of. It may pose a danger if the car is involved in an accident.

1. A method of hanging personal items such as clothes, grocery bags, purses etc. from an automobile car seat headrest using a Device with a curved hook end that hangs onto the support bar of the headrest, which can be either extended up or down to the seatback.

2. The Device apparatus claim, wherein the Device has two like curved hook ends, one on each end, pointing in different directions, angles and planes, wherein:
One curved hook end is used to hang from the headrest support bar; and
The other curved hook end is used to hang personal items.

3. The Device apparatus claim, wherein the Device can be instantly placed or removed on the front or back of an automobile headrest support bar, wherein:
No physical alteration of a headrest or its support bar(s) is needed; and
No removal of either the headrest or support bar(s) is needed; and
The Device does not require permanent fastening to a headrest support bar(s) to be used.

4. The Device apparatus claim, wherein the Device does not require any additional attachments, hardware (i.e. nuts, bolts) or assembly to be used and:
The Device consists of one piece with no moving parts.
